(19) United States
(12) Patent Application Publication
(10) Pub. No.: US 2019/0370906 A1
(43) Pub. Date: Dec. 5, 2019

(54) ECONOMIC VALUE PROCESSING SYSTEM AND SERVER

(71) Applicant: TOYOTA JIDOSHA KABUSHIKI KAISHA, Toyota-shi (JP)

(72) Inventor: Yoshihiro Sakayanagi, Mishima-shi (JP)

(73) Assignee: TOYOTA JIDOSHA KABUSHIKI KAISHA, Toyota-shi (JP)

(21) Appl. No.: 16/430,774

(22) Filed: Jun. 4, 2019

(30) Foreign Application Priority Data
Jun. 5, 2018 (JP) 2018-107925

(51) Int. Cl. G06Q 40/00; G06Q 30/02

(52) U.S. Cl. CPC G06Q 40/12; G06Q 30/0224

(57) ABSTRACT

An economic value processing system comprised of a plurality of vehicles able to communicate with each other and managing economic values respectively held by the plurality of vehicles or users of the plurality of vehicles. The economic value processing system is configured to decrease the economic value held by one vehicle or the user of one vehicle and increase the economic value held by the other vehicle or the user of the other vehicle when, based on the pass request signal sent from one vehicle among the plurality of vehicles to the other vehicle, the other vehicle has changed lanes or the other vehicle has finished being passed by the one vehicle.

### CROSS-REFERENCE TO RELATED APPLICATION

This application claims priority based on Japanese Patent Application No. 2018-107925 filed with the Japan Patent Office on Jun. 5, 2018, the entire contents of which are incorporated into the present specification by reference.

### FIELD

The present disclosure relates to an economic value processing system and server.

### BACKGROUND

Japanese Unexamined Patent Publication No. 2005-190233 discloses a road management system giving a discount on road tolls or other economic value to vehicles driving on a driving lane among a driving lane and passing lane so as to encourage them to positively drive on the driving lane.

### SUMMARY

As a method for encouraging positive driving on a driving lane, in addition to the method described in the above-mentioned patent publication, for example, the method of making a vehicle driving on a passing lane pay economic value may be considered. However, sometimes there will be a vehicle driving at a slow speed in the front on the passing lane. In such a case, even if paying greater economic value to drive on the passing lane, whether the vehicle in front will change lanes to the driving lane is left to the driver of the vehicle in front. Therefore, even if having paid greater economic value to drive on the passing lane, it will not be possible to pass the vehicle in front and therefore it is liable to be impossible to obtain a benefit commensurate with the payment of economic value.

The present disclosure was made in consideration of such a problem and has as its object to provide an economic value processing system and server enabling one to obtain a benefit commensurate with the payment of economic value.

To solve this problem, according to one aspect of the present disclosure, there is provided an economic value processing system comprised of a plurality of vehicles able to communicate with each other and managing economic values held by the plurality of vehicles or users of the plurality of vehicles. Further, when, based on a pass request signal sent from one vehicle among the plurality of vehicles to other vehicle, the other vehicle has changed lanes or the other vehicle has finished being passed by the one vehicle, the economic value processing system is configured to decrease the economic value held by the one vehicle or the user of one vehicle and increase the economic value held by the other vehicle or the user of the other vehicle.

Further, according to another aspect of the present disclosure, there is provided a server comprised of a communication part able to communicate with a plurality of mutually different vehicles, a storage part storing economic values respectively held by the plurality of vehicles or the users of the plurality of vehicles, and a control part managing the economic values. Further, the control part is configured so that when receiving from one vehicle among the plurality of vehicles a pass request signal for other vehicle, it notifies the other vehicle that a pass request has arrived from the one vehicle and so that when the other vehicle changes lanes or the other vehicle finishes being passed by the one vehicle, it decreases the economic value held by the one vehicle or the user of the one vehicle and increases the economic value held by the other vehicle or the user of the other vehicle.

According to these aspects of the present disclosure, it is possible to keep the situation of not being able to pass a vehicle in the front despite having paid economic value from occurring, so it is possible to obtain benefits commensurate with payment of the economic value.

### BRIEF DESCRIPTION OF DRAWINGS

FIG. 1 is a schematic view of the configuration of an economic value processing system according to a first embodiment of the present disclosure.

FIG. 2 is a schematic view of the configuration of a car-mounted system relating to the economic value processing system.

FIG. 3 is a view showing one example of the state when processing relating to the transfer of economic value accompanying a pass request is performed in the economic value processing system according to the first embodiment of the present disclosure.

FIG. 4 is a view showing one example of the operational sequence of processing relating to the transfer of economic value accompanying a pass request according to the first embodiment of the present disclosure performed by a control device of the vehicle sending the pass request and a control device of the vehicle receiving the pass request.

FIG. 5 is a flow chart explaining the content of the processing relating to the transfer of economic value accompanying a pass request performed by the control device of the vehicle sending the pass request.

FIG. 6 is a flow chart explaining the content of the processing relating to the transfer of economic value accompanying a pass request performed by the control device of the vehicle receiving the pass request.

FIG. 7 is a schematic view of the configuration of an economic value processing system according to a second embodiment of the present disclosure.

FIG. 8 is a view showing one example of the operational sequence of processing relating to the transfer of economic value accompanying a pass request according to the second embodiment of the present disclosure performed by a control device of the vehicle sending the pass request, a control device of the vehicle receiving the pass request, and a control part of a server.

FIG. 9 is a flow chart explaining the content of the processing relating to the transfer of economic value accompanying a pass request according to the second embodiment of the present disclosure performed by the server.

### DESCRIPTION OF EMBODIMENTS

Below, referring to the figures, embodiments of the present disclosure will be explained in detail. Note that, in the following explanation, similar component elements are assigned the same reference notations.

### First Embodiment

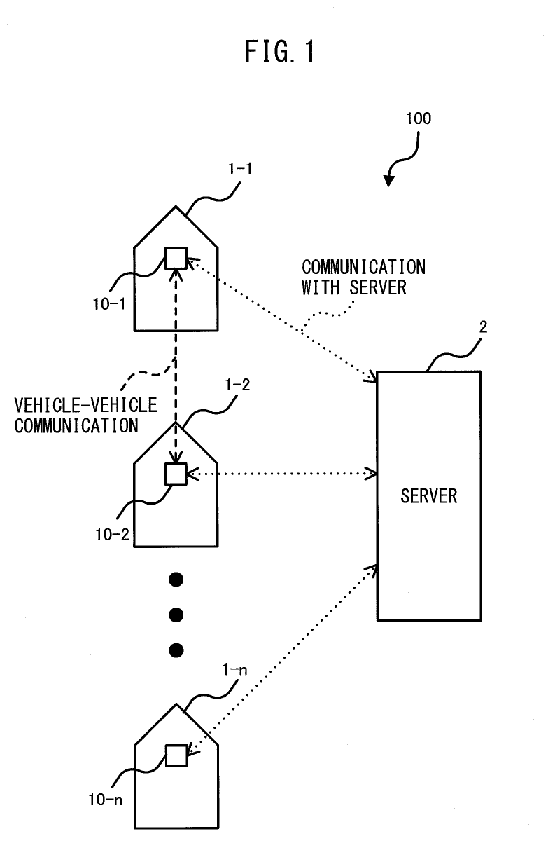

FIG. 1 is a schematic view of the configuration of an economic value processing system 100 according to a first embodiment of the present disclosure.

The economic value processing system 100 according to the present embodiment is comprised of a plurality of vehicles 1-1 to 1-n (“n” is an integer of 3 or more) and a server 2.

Further, the economic value processing system 100 is configured so that the vehicles 1-1 to 1-n can communicate with the server 2 and purchase for example virtual currency or electronic money, points issued by companies, gift certificates, and other economic value through the server 2. Further, the economic value processing system 100 is configured so that among the vehicles 1-1 to 1-n, two vehicles driving one after the other at the front and rear can communicate and the vehicle positioned at the rear can make a pass request to the vehicle positioned in the front (for example, a request for a lane change from the passing lane to a driving lane). Furthermore, the economic value processing system 100 is configured so that economic value is transferred between the two vehicles when the pass request has been completed (that is, when the vehicle in the front has changed lanes or when the vehicle in the front has finished being passed).

The vehicles 1-1 to 1-n respectively mount car-mounted systems 10-1 to 10-n relating to this economic value processing system 100.

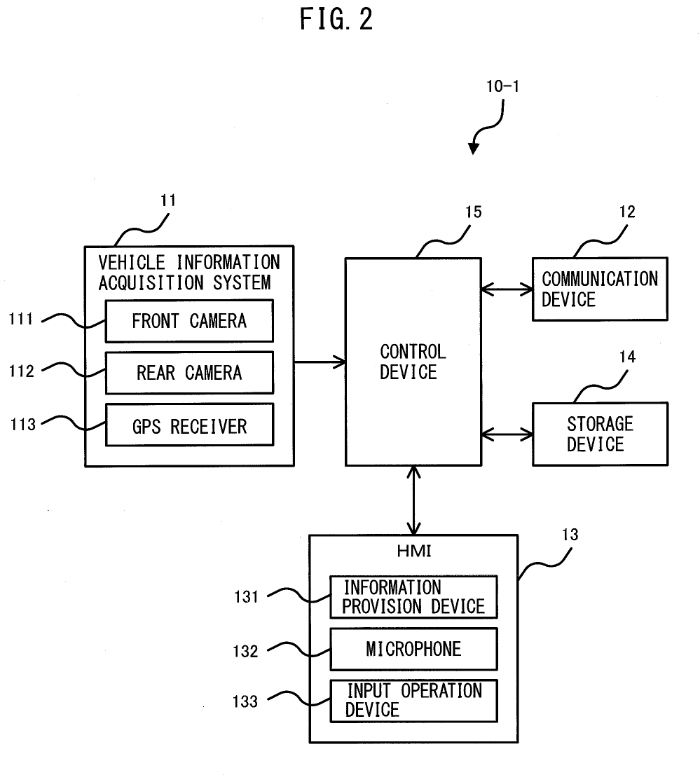

FIG. 2 is a schematic view of the configuration of a car-mounted system 10-1 mounted in the vehicle 1-1. Note that, the car-mounted systems 10-2 to 10-n mounted in the vehicles 1-2 to 1-n are configured in the same way as this car-mounted system 10-1, so here the configuration of the car-mounted system 10-1 will be explained as a representative example.

The car-mounted system 10-1 comprises a vehicle information acquisition system 11, communication device 12, human machine interface (HMI) 13, storage device 14, and control device 15. Note that, the communication device 12, HMI 13, storage device 14, and control device 15 do not necessarily have to be mounted in the vehicle 1-1 in advance. For example, a terminal combining these may also be carried into the vehicle 1-1 to thereby form the car-mounted system 10-1.

The vehicle information acquisition system 11 is a system for acquiring information relating to the vehicle 1-1 and surrounding vehicles of the vehicle 1-1 (below, referred to as the “vehicle information”). In the present embodiment, as the vehicle information acquisition system 11, a front camera 111, rear camera 112, and GPS receiver 113 are mounted in the vehicle 1-1.

The front camera 111 captures a picture of the road in front of the vehicle 1-1. The front camera 111 processes the captured front picture of the vehicle 1-1 by image processing to detect which lane of the driving lane and passing lane the vehicle 1-1 is driving on and, if there is a vehicle driving in front of the vehicle 1-1, further detects a license plate number of the vehicle in the front and the distance to the vehicle in the front. Further, the front camera 111 sends the control device 15 these detected information as front capture information.

The rear camera 112 captures a picture of the road at the rear of the vehicle 1-1. The rear camera 112 processes the captured rear picture of the vehicle 1-1 by image processing to detect a license plate number of the vehicle at the rear if there is a vehicle driving at the rear of the vehicle 1-1. Further, the rear camera 112 sends the control device 15 the information of the detected license plate number of the vehicle at the rear.

The GPS receiver 113 receives signals from three or more GPS satellites to identify the latitude and longitude of the vehicle 1-1 and detect the current position of the vehicle 1-1. The GPS receiver 113 sends the detected current position of the vehicle 1-1 to the control device 15.

The communication device 12 is provided with a vehicle-vehicle communication function enabling communication with vehicles surrounding the vehicle 1-1 and a server 2 communication function enabling communication with the server 2 and is configured so that various types of data can be transferred with the control device 15.

The HMI 13 is an interface for input/output of information between a vehicle occupant and the control device 15. The HMI 13 in the present embodiment is comprised of an information provision device 131 for providing various types of information to the vehicle occupant, a microphone 132 for recognizing the voice of the driver, and a touch panel or operating buttons or other input operation device 133 on which the driver performs input operations. The information provision device 131, for example, is a display for displaying text information or image information, a speaker for generating sound, etc.

The storage device 14 stores economic value held by the vehicle 1-1 or the owner of the vehicle 1-1. Further, the storage device 14 stores map information. The map information includes position information of the roads or information on the road shapes (for example, whether curved or straight, curvature of curves, etc.), position information of intersections and turnoffs, road types, and other information.

Note that, by mounting the storage device 14 in the vehicle 1-1 in advance, it is possible to link economic value stored in the storage device 14 with the vehicle 1-1. That is, it is possible to establish a state where the vehicle 1-1 holds economic value. Further, as explained above, by making the storage device 14 a component part of a terminal able to be carried into the vehicle 1-1, it is possible to link economic value stored in the storage device 14 with the user of the terminal. As a result, it is possible to establish a state where the user of the vehicle 1-1 holds economic value.

Further, by treating the economic value stored in the storage device 14 as, for example, gift certificates issued by companies, the economic value handled by the economic value processing system 100 according to the present embodiment will not be treated as a financial product. For this reason, it is possible to prevent taxes being assessed for the transfer of economic value between two vehicles accompanying a pass request. Further, even by making the upper limit of the economic value stored in the storage device 14 the depreciation amount of the vehicle 1-1, it is possible to prevent taxes being assessed for the transfer of economic value between two vehicles accompanying a pass request.

Therefore, which of the above-mentioned virtual currency or electronic money, points issued by companies, gift certificates, etc. to make the economic value handled by the economic value processing system 100 according to the present embodiment is preferably determined by suitably selecting the optimum one considering such taxes etc.

The control device 15 is a microcomputer provided with components connected with each other by a bidirectional bus such as a central processing unit (CPU), read only memory (ROM), random access memory (RAM), input port, and output port.

The control device 15 sends a purchase request signal of economic value corresponding to a charged amount to the server 2 through the communication device 12 when an occupant of the vehicle 1-1 for example operates the input operation device 133 to indicate his intent to purchase economic value through the HMI 13 or when the economic value stored in the storage device 14 is a predetermined amount or less. As a result, economic value corresponding to the charged amount is given from the server 2 receiving the purchase request signal of the economic value to the vehicle 1-1 through the communication device 12 and the amount of the economic value stored in the storage device 14 is updated.

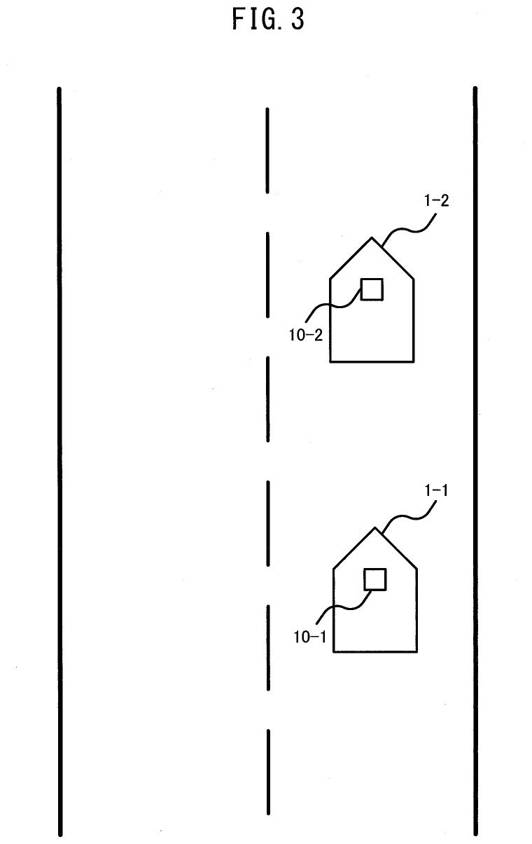

Further, the control device 15 performs processing relating to the transfer of economic value accompanying a pass request between two vehicles driving one after the other at the front and rear among the vehicles 1-1 to 1-n. Below, referring to FIG. 3 to FIG. 6, the specific content of the processing relating to the transfer of economic value accompanying this pass request will be explained.

FIG. 3 is a view showing one example of the state when processing relating to the transfer of economic value accompanying a pass request is performed in the economic value processing system 100 according to the present embodiment. In the example shown in FIG. 3, the vehicle 1-1 and the vehicle 1-2 are driving one after the other at the front and rear on the passing lane. Further, it is assumed that the vehicle 1-1 positioned at the rear on the passing lane tries to make a pass request to the vehicle 1-2 to pass the vehicle 1-2 positioned at the front.

Note that, in the following explanation, for convenience, in accordance with need, the vehicle sending the pass request (in the example shown in FIG. 3, the vehicle 1-1) will be referred to as the “request-sending vehicle”, while the vehicle receiving the pass request (in the example shown in FIG. 3, the vehicle 1-2) will be referred to as the “request-receiving vehicle”.

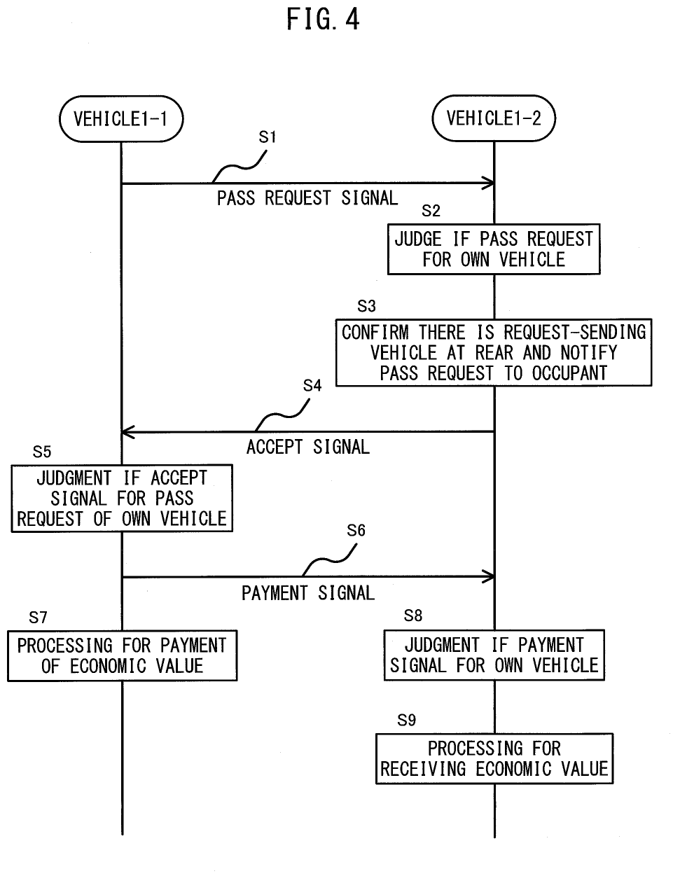

FIG. 4 is a view showing one example of the operational sequence of processing relating to the transfer of economic value accompanying a pass request performed by control devices 15 of the vehicles 1-1 and 1-2 in the state shown in FIG. 3.

At step S1, if an occupant of the vehicle 1-1 sending the pass request, for example, operates the input operation device 133 to set the driving mode of the vehicle 1-1 to the passing mode etc. so as to indicate through the HMI 13 his intent to pass the vehicle 1-2 in the front, the control device 15 of the vehicle 1-1 judges if the distance to the vehicle 1-2 in the front is less than a predetermined distance. Further, if the distance to the vehicle 1-2 in the front becomes less than the predetermined distance, the control device 15 of the vehicle 1-1 sends a pass request signal including the license plate number of its own vehicle 1-1 and the license plate number of the vehicle receiving the pass request, that is, the license plate number of the vehicle 1-2 in the front, to the vehicle 1-2 by vehicle-vehicle communication through the communication device 12.

At step S2, the control device 15 of the vehicle 1-2 receiving the pass request signal through the communication device 12 judges if the pass request is a request to its own vehicle 1-2. The control device 15 of the vehicle 1-2 judges that it is a pass request to its own vehicle 1-2 if the license plate number of the vehicle receiving the pass request included in the pass request signal matches the license plate number of its own vehicle 1-2, then proceeds to the processing of step S3. On the other hand, the control device 15 of the vehicle 1-2 ends the processing if the license plate number of the vehicle receiving the pass request included in the pass request signal does not match the license plate number of its own vehicle 1-2.

In this example, the pass request signal which the vehicle 1-2 received is a pass request to the vehicle 1-2 sent from the vehicle 1-1. The license plate number of the request-receiving vehicle of the pass request included in the pass request signal and the license plate number of its own vehicle 1-2 match, so the control device 15 of the vehicle 1-2 proceeds to the processing of step S3.

At step S3, if the license plate number of the vehicle at the rear detected by the rear camera 112 matches with the license plate number of the vehicle 1-1 sending the pass request included in the pass request signal, the control device 15 of the vehicle 1-2 notifies the occupant of the vehicle 1-2 through the HMI 13 that a pass request has arrived from the vehicle at the rear and requests his/her judgment of whether to accept the pass request.

At step S4, if an occupant of the vehicle 1-2 operates the input operation device 133 to indicate his willingness to accept the pass request through the HMI 13, the control device 15 of the vehicle 1-2 sends an accept signal indicating the intent to accept the pass request including the license plate number of its own vehicle 1-2 to the vehicle 1-1 by vehicle-vehicle communication through the communication device 12. On the other hand, if an occupant of the vehicle 1-2 operates the input operation device 133 to indicate the intent of rejecting the pass request through the HMI 13 or if the occupant of the vehicle 1-2 has not indicated any intent through the HMI 13 even if a predetermined time elapses from when being notified that a pass request has arrived, the control device 15 of the vehicle 1-2 sends the vehicle 1-1 a reject signal showing rejection of the pass request including the license plate number of its own vehicle 1-2 by vehicle-vehicle communications through the communication device 12.

This example shows the case where an occupant of the vehicle 1-2 indicates a willingness to accept a pass request through the HMI 13. The control device 15 of the vehicle 1-2 sends an accept signal by vehicle-vehicle communications through the communication device 12 to the vehicle 1-1.

At step S5, if its own vehicle had made the pass request, the control device 15 of the vehicle 1-1 receiving the accept signal through the communication device 12 judges if the received accept signal is a reply to the pass request of its own vehicle. In this case, the control device 15 of the vehicle 1-1 judges that the received accept signal is a reply to the pass request of its own vehicle 1-1 if the license plate number contained in the accept signal, that is, the license plate number of the vehicle indicating willingness to accept a pass request, matches with the license plate number of the request-receiving vehicle 1-2 to which its own vehicle 1-1 makes a pass request, then proceeds to the processing of step S6. On the other hand, the control device 15 of the vehicle 1-1 ends the processing if its own vehicle 1-1 had not make the pass request.

In this example, the license plate number contained in the accept signal is the license plate number of the request-receiving vehicle 1-2 to which the pass request is made, so the control device 15 of the vehicle 1-1 proceeds to the processing of step S6.

At step S6, if the control device 15 of the vehicle 1-1 judges that the vehicle 1-2 has finished being passed based on the picture of the surroundings of the vehicle 1-1 detected by one or both of the front camera 111 and the rear camera 112, it sends an economic value payment signal including the license plate number of its own vehicle 1-1 to the vehicle 1-2 by vehicle-vehicle communication through the communication device 12, then proceeds to the processing of step S7. The control device 15 of the vehicle 1-1, for example, judges that the vehicle 1-2 has finished being passed when the vehicle 1-2 no longer appears in the front picture captured by the front camera 111, when the vehicle 1-2 appears in the rear picture captured by the rear camera 112, etc.

At step S7, the control device 15 of the vehicle 1-1 performs processing for payment of economic value for the completion of the pass request. Specifically, the control device 15 of the vehicle 1-1 decreases the economic value stored in the storage device 14 of the vehicle 1-1 by exactly a first predetermined amount.

At step S8, the control device 15 of the vehicle 1-2 receiving the payment signal through the communication device 12 judges if the received payment signal is a payment signal to its own vehicle 1-2 when its own vehicle 1-2 had sent an accept signal for the pass request. In this case, the control device 15 of the vehicle 1-2 judges that the received payment signal is a payment signal for its own vehicle 1-2 if the license plate number contained in the payment signal, that is, the license plate number of the vehicle indicating willingness to pay economic value, matches the license plate number of the vehicle 1-1 to which its own vehicle 1-2 had sent the accept signal, then proceeds to the processing of step S9. On the other hand, the control device 15 of the vehicle 1-2 ends the processing if its own vehicle 1-2 had not sent the accept signal.

In this example, the license plate number of the vehicle contained in the payment signal is the license plate number of the vehicle 1-1 to which its own vehicle 1-2 had sent the accept signal, so the control device 15 of the vehicle 1-2 proceeds to the processing of step S9.

At step S9, the control device 15 of the vehicle 1-2 performs processing for receiving the economic value for having agreed to the pass request. Specifically, the control device 15 of the vehicle 1-2 increases the economic value stored in the storage device 14 of the vehicle 1-2 by exactly a second predetermined amount. Note that, in the present embodiment, this second predetermined amount is made an amount smaller than the first predetermined amount.

By making the amount of the economic value paid from the sender of the pass request greater than the amount of economic value received by the receiver of the pass request, the economic value issued from the server 2 is decreased by exactly the difference of the first predetermined amount and the second predetermined amount each time economic value is transferred accompanied with a pass request. For this reason, the side issuing the economic value can obtain that reduced amount as a benefit (handling fee).

Note that, in the example shown in FIG. 4, at step S6, economic value is transferred between the request sender (vehicle 1-1) and the request receiver (vehicle 1-2) of the pass request after it is judged that the vehicle 1-2 has finished being passed, but the timing of transfer of economic value is not limited to this. For example, the economic value may also be transferred at the timing when the request-receiving vehicle of the pass request changes lanes from the passing lane to a driving lane.

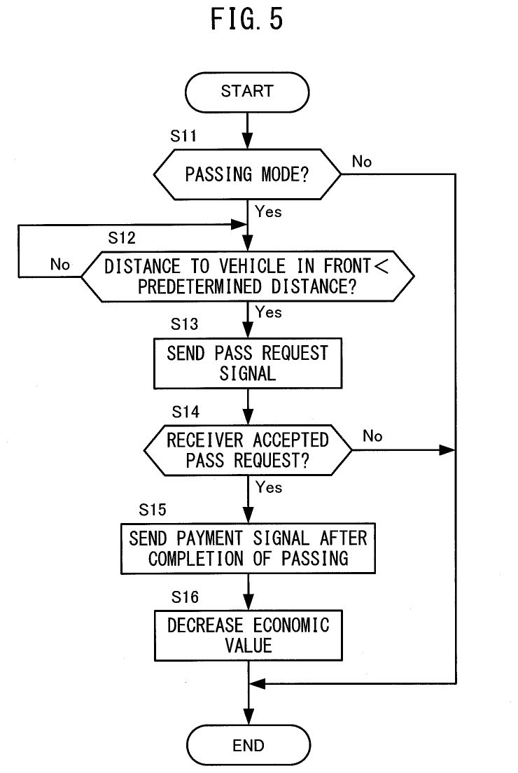

FIG. 5 is a flow chart explaining content of processing relating to transfer of economic value accompanying a pass request performed by the control device 15 of the vehicle 1-1 if the vehicle 1-1 sends a pass request.

At step S11, the control device 15 of the vehicle 1-1 judges if the driving mode of the vehicle 1-1 is set to the passing mode. The control device 15 of the vehicle 1-1 judges that an occupant of its own vehicle has indicated his intent of passing the vehicle in the front if the driving mode of the vehicle 1-1 is set to the passing mode, then proceeds to the processing of step S12. On the other hand, the control device 15 of the vehicle 1-1 ends the processing if the driving mode of the vehicle 1-1 is not set to the passing mode.

At step S12, the control device 15 of the vehicle 1-1 judges if the distance to the vehicle in the front is less than a predetermined distance. The control device 15 of the vehicle 1-1 proceeds to the processing of step S13 if the distance to the vehicle in the front is less than the predetermined distance. On the other hand, if the distance to the vehicle in the front is the predetermined distance or more, the control device 15 of the vehicle 1-1 stands by until the distance to the vehicle in the front becomes less than the predetermined distance.

At step S13, the control device 15 of the vehicle 1-1 sends a pass request signal to the vehicle receiving the pass request (request-receiving vehicle) by vehicle-vehicle communication through the communication device 12.

At step S14, the control device 15 of the vehicle 1-1 judges if the request-receiving vehicle has agreed to the pass request. The control device 15 of the vehicle 1-1 judges that the request-receiving vehicle has agreed to the pass request if receiving an accept signal from the request-receiving vehicle within a predetermined time from when sending the pass request signal, then proceeds to the processing of step S15. On the other hand, the control device 15 of the vehicle 1-1 judges that the request-receiving vehicle has rejected pass request if receiving a reject signal from the request-receiving vehicle within a predetermined time from when sending the pass request signal or when not receiving any signal from the request-receiving vehicle within the predetermined time from when sending the pass request, then ends the processing.

At step S15, if the control device 15 of the vehicle 1-1 judges that the request-receiving vehicle has finished being passed based on the picture of the surroundings of the vehicle 1-1 detected by one or both of the front camera 111 and the rear camera 112, it sends the request-receiving vehicle a payment signal indicating willingness to pay economic value by vehicle-vehicle communication through the communication device 12.

At step S16, the control device 15 of the vehicle 1-1 decreases the economic value stored in the storage device 14 by exactly a first predetermined amount.

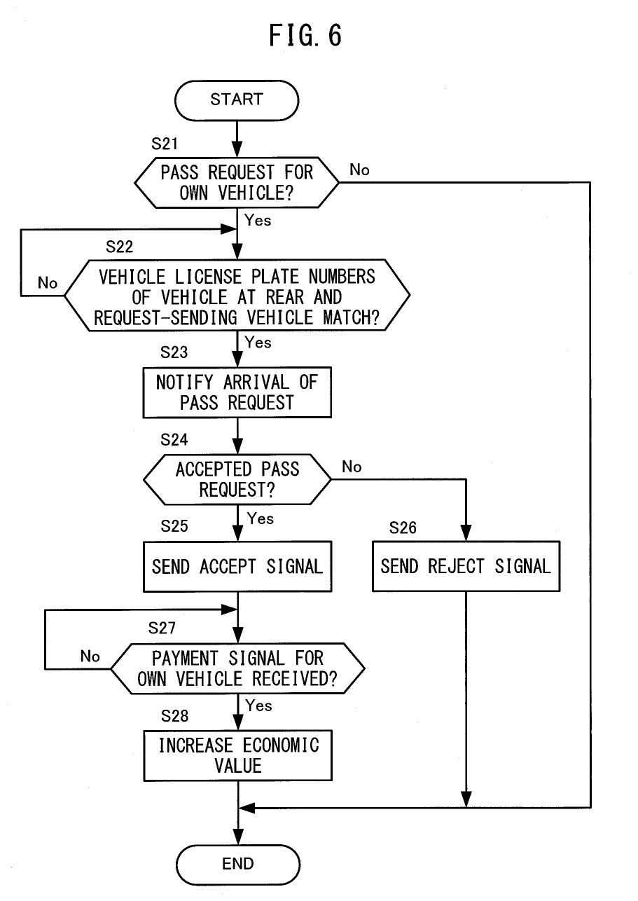

FIG. 6 is a flow chart explaining the content of the processing relating to the transfer of economic value accompanying a pass request performed by the control device 15 of the vehicle 1-1 when the vehicle 1-1 receives a pass request. The control device 15 of the vehicle 1-1 starts this processing if receiving a pass request signal through the communication device 12.

At step S21, the control device 15 of the vehicle 1-1 judges if the pass request is a request to its own vehicle. The control device 15 of the vehicle 1-1 judges that the pass request is a request to its own vehicle if the license plate number of the request-receiving vehicle of the pass request included in the pass request signal matches the license plate number of its own vehicle, then proceeds to the processing of step S22. On the other hand, the control device 15 of the vehicle 1-1 judges that the pass request is not a request to its own vehicle if the license plate number of the request-receiving vehicle of the pass request included in the pass request signal does not match the license plate number of its own vehicle, then ends the processing.

At step S22, the control device 15 of the vehicle 1-1 judges if the license plate number of the vehicle at the rear detected by the rear camera 112 matches the license plate number of the vehicle sending the pass request included in the pass request signal. The control device 15 of the vehicle 1-1 proceeds to the processing of step S23 if the license plate number of the vehicle at the rear matches the license plate number of the request-sending vehicle. On the other hand, if the license plate number of the vehicle at the rear does not match the license plate number of the request-sending vehicle, the control device 15 of the vehicle 1-1 stands by until they match.

At step S23, the control device 15 of the vehicle 1-1 notifies an occupant of its own vehicle through the HMI 13 that a pass request has arrived from a vehicle at the rear and requests judgment of whether to accept that pass request.

At step S24, the control device 15 of the vehicle 1-1 judges if an occupant of its own vehicle has accepted the pass request from the vehicle at the rear. The control device 15 of the vehicle 1-1 judges that the occupant of its own vehicle has accepted the pass request from the vehicle at the rear if the occupant of its own vehicle indicates his intent of accepting the pass request through the HMI 13 within a predetermined time from when the pass request is notified, then proceeds to the processing of step S25. On the other hand, the control device 15 of the vehicle 1-1 judges that the occupant of its own vehicle has rejected the pass request from the vehicle at the rear if the occupant of its own vehicle indicates his intent of rejecting the pass request through the HMI 13 within a predetermined time from when the pass request is notified or if no intent at all is indicated, then proceeds to the processing of step S26.

At step S25, the control device 15 of the vehicle 1-1 sends the request-sending vehicle an accept signal by vehicle-vehicle communication through the communication device 12.

At step S26, the control device 15 of the vehicle 1-1 sends the request-sending vehicle a reject signal by vehicle-vehicle communication through the communication device 12.

At step S27, if receiving a payment signal through the communication device 12, the control device 15 of the vehicle 1-1 judges if the received payment signal is a payment signal to its own vehicle. The control device 15 of the vehicle 1-1 judges that the received payment signal is a payment signal to its own vehicle if the license plate number of the request-sending vehicle included in the payment signal matches the license plate number of the vehicle to which its own vehicle has sent the accept signal, then proceeds to the processing of step S28. On the other hand, if the license plate number of the request-sending vehicle included in the payment signal does not match the license plate number of the vehicle to which its own vehicle has sent the accept signal, the control device 15 of the vehicle 1-1 stands by until receiving a payment signal to its own vehicle.

At step S28, the control device 15 of the vehicle 1-1 increases the economic value of the vehicle 1-1 stored in the storage device 14 by exactly a second predetermined amount.

According to the present embodiment explained above, the economic value processing system 100 comprises a plurality of vehicles 1-1 to 1-n able to communicate with each other and manages the economic values respectively held by the plurality of vehicles 1-1 to 1-n or the users of the plurality of vehicles 1-1 to 1-n. Further, when, based on a passing request signal sent from one vehicle among the plurality of vehicles 1-1 to 1-n to other vehicle, the other vehicle changes lanes or the other vehicle changing lanes finishes being passed, the economic value processing system 100 is configured to decrease the economic value held by the one vehicle or the user of one vehicle and increase the economic value held by the other vehicle or the user of the other vehicle.

Due to this, it is possible to keep the situation of not being able to pass a vehicle in the front despite having paid economic value from occurring, so it is possible to obtain benefits commensurate with payment of the economic value. Further, a vehicle desiring to pass a vehicle in the front can smoothly pass it by payment of economic value.

Further, usually, between the side doing the passing and the side being passed, the side being passed is one-sidedly disadvantaged. There has been a lack of fairness between the side doing the passing and the side being passed. According to the present embodiment, however, the side being passed can receive economic value, so such a sense of unfairness can be kept from occurring.

Further, the economic value processing system 100 according to the present embodiment is configured so that the amount of decrease when decreasing the economic value held by one vehicle sending the pass request or the user of one vehicle becomes greater than the amount of increase when increasing the economic value held by the other vehicle receiving the pass request or the user of the other vehicle.

In this way, by making the amount of economic value which the side doing the passing (request sender) pays greater than the economic value which the side being passed (request receiver) receives, the economic value issued from the issuer of economic value is reduced by exactly the difference between the amount of economic value which the side doing the passing pays and the amount of economic value which the side being passed receives each time economic value is transferred accompanying a pass request. For this reason, the issuer of the economic value can obtain the reduced amount as a benefit (handling fee).

Further, the economic value processing system 100 according to the present embodiment further comprises a server 2 able to communicate with the plurality of vehicles 1-1 to 1-n. Further, the server 2 is configured to grant economic value corresponding to a charge to a vehicle sending a purchase request signal or the user of that vehicle when receiving a purchase request signal of economic value including a charge from the plurality of vehicles 1-1 to 1-n. At this time, when the economic values held by the plurality of vehicles 1-1 to 1-n or the users of the plurality of vehicles 1-1 to 1-n become predetermined amounts or less, purchase request signals may be automatically sent from the plurality of vehicles 1-1 to 1-n to the server 2 and the trouble of performing procedures for purchasing economic vehicle when the vehicle is being driven can be eliminated.

### Second Embodiment

Next, a second embodiment of the present disclosure will be explained. The economic value processing system 100 according to the present embodiment differs from the first embodiment in that it performs part of the processing relating to transfer of economic value accompanying a pass request by the server 2. Below, this point of difference will be focused on in the explanation.

In the above-mentioned first embodiment, two vehicles driving one after the other at the front and rear directly communicated to transfer economic value. For this reason, strangers not acquainted with each other have to directly transfer economic value. It is liable to be impossible to sufficiently secure reliability with respect to the transfer of economic value. Further, if a pass request directly arrives from a stranger with which one is not acquainted, one might feel uncomfortable and reject the pass request.

Therefore, in the present embodiment, by performing part of the processing relating to the transfer of economic value accompanying a pass request by the server 2 which the provider of the economic value processing system 100 manages, it was made possible to secure the reliability with respect to transfer of economic value and indirectly make a pass request through the server 2 from the request-sending vehicle to the request-receiving vehicle.

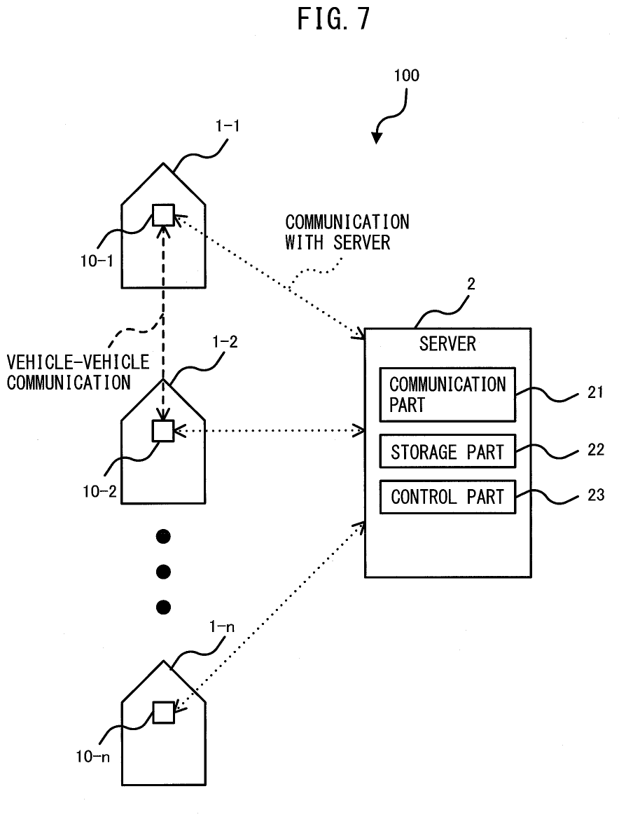

FIG. 7 is a schematic view of the configuration of an economic value processing system 100 according to a second embodiment of the present disclosure. Note that, the configurations of the car-mounted systems 104 to 10-n mounted in the vehicles 1-1 to 1-n are similar to the first embodiment, so here the explanations will be omitted. The detailed configuration of the server 2 will be explained below:

The server 2 is comprised of a communication part 21, storage part 22, and control part 23. The communication part 21 and storage part 22 are connected with the control part 23 through signal lines. The server 2 may be further provided with an input device such as a keyboard or mouse and an output device such as a display.

The communication part 21 is configured to be able to communicate with the communication devices 12 of the vehicles 1-1 to 1-n through a communication network.

The storage part 22, for example, comprises a hard disk drive or optical recording medium and a device for accessing the same. It stores the identification information and current position of the vehicles 1-1 to 1-n and the economic values held by the vehicles 1-1 to 1-n or the users of the vehicles 1-1 to 1-n etc. linked together and stores map information. The identification information of the vehicles 1-1 to 1-n can, for example, be made the license plate numbers of the vehicles 1-1 to 1-n.

Further, the storage part 22, for example, is provided with a nonvolatile semiconductor memory and a volatile semiconductor memory and stores various types of data etc. generated during the performance of the processing relating to transfer of economic value accompanying a pass request.

The control part 23 comprises one or more CPUs (central processing units) and their peripheral circuits. The control part 23 may further comprise other processing circuits such as logic processing units or numeric processing units. Further, the control part 23 performs processing relating to the server 2 in the processing for transfer of economic value accompanying a pass request.

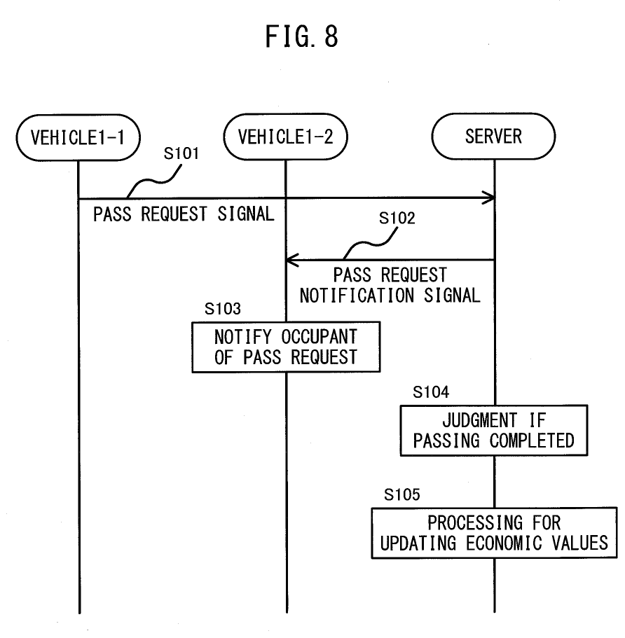

FIG. 8 is a view showing one example of the operational sequence of processing relating to the transfer of economic value accompanying a pass request performed by a control devices 15 of the vehicles 1-1 and 1-2 and a control part 23 of a server 2, in the situation shown in FIG. 3.

At step S101, if an occupant of the vehicle 1-1 sending the pass request, for example, operates the input operation device 133 to set the driving mode of the vehicle 1-1 to the passing mode etc. so as to indicate through the HMI 13 his intent to pass the vehicle in the front, the control device 15 of the vehicle 1-1 judges if the distance to the vehicle in the front is less than a predetermined distance. Further, if the distance to the vehicle in the front becomes less than the predetermined distance, it sends a pass request signal including identification information of its own vehicle 1-1 sending the pass request and identification information of the vehicle in the front 1-2 receiving the pass request through the communication device 12 to the server 2.

At step S102, the server 2 receiving the pass request signal identifies the vehicles 1-1 and 1-2 from the identification information of the vehicles 1-1 and 1-2 contained in the pass request signal and sends the vehicle 1-2 a pass request notification signal for notifying it that a pass request has arrived from the vehicle 1-1.

At step S103, the control device 15 of the vehicle 1-2 in the front receiving the pass request notification signal notifies the occupant of the vehicle 1-2 through the HMI 13 that a pass request has arrived from the vehicle 1-1 at the rear.

At step S104, the server 2 judges if the vehicle 1-1 sending the pass request has finished passing the vehicle 1-2 receiving the pass request, that is, if the pass request has been completed, based on the current position information of the vehicles 1-1 and 1-2 sent from the communication devices 12 of the vehicles 1-1 and 1-2 every predetermined time and, if the pass request has been completed, proceeds to the processing of step S105.

At step S105, the server 2 updates the amounts of economic values held by the vehicles 1-1 and 1-2 stored in the server 2. Specifically, the server 2 decreases the economic value held by the vehicle 1-1 sending the pass request by an amount corresponding to the total of the pass request charge and the handling fee. Further, the server 2 increases the economic value held by the vehicle 1-2 receiving the request by exactly an amount corresponding to the pass request charge. By reducing the economic value held by the sender of the pass request by the handling fee in this way, the issuer of the economic value can obtain the handling fee as a benefit.

Note that, in the example shown in FIG. 8, the judgment of whether passing had been completed was performed by the server 2, but, for example, like in the first embodiment, the judgment of whether passing had been completed may also be performed by the vehicle 1-1 sending the pass request and the processing for updating the economic value may be performed when the server 2 receives a payment signal sent from the vehicle 1-1 side.

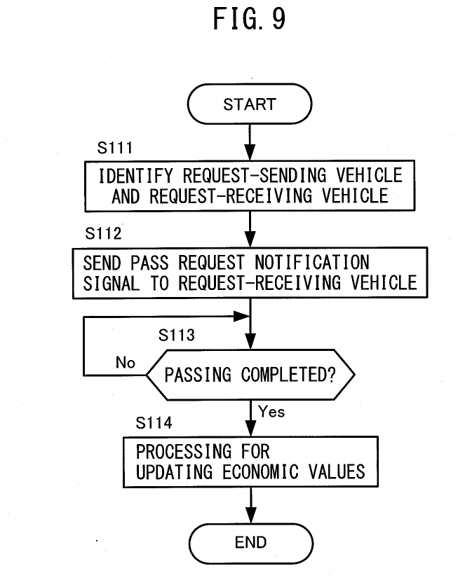

FIG. 9 is a flow chart explaining the content of the processing relating to the transfer of economic value accompanying a pass request performed by the server 2 in the present embodiment. The server 2 starts this processing when receiving a pass request signal through the communication device 12.

At step S111, the server 2 identifies the request-sending vehicle and request-receiving vehicle based on identification information of the request-sending vehicle and request-receiving vehicle contained in the pass request signal.

At step S112, it sends the request-receiving vehicle a pass request notification signal for notifying the vehicle that a pass request from the request-sending vehicle had arrived.

At step S113, the server 2 judges if the request-sending vehicle has finished passing the request-receiving vehicle, that is, if the pass request has been completed, based on the current position information of the vehicles sent from the request-sending vehicle and request-receiving vehicle every predetermined time. The server 2 continues to perform this judgment until the pass request is completed. If the pass request is completed, it proceeds to the processing of step S114.

At step S114, the server 2 updates the amounts of economic value held by the request-sending vehicle and request-receiving vehicle stored in the server 2. Specifically, the server 2 decreases the economic value held by the request-sending vehicle by an amount corresponding to the total of the pass request charge and the handling fee. Further, the server 2 increases the economic value held by the request-receiving vehicle by exactly an amount corresponding to the pass request charge.

The server 2 according to the present embodiment explained above comprises a communication part 21 able to communicate with a plurality of mutually different vehicles 1-1 to 1-n, a storage part 22 storing the economic values respectively held by the plurality of vehicles 1-1 to 1-n or the users of the plurality of vehicles 1-1 to 1-n, and a control part 23 managing the economic values.

Further, when receiving from one vehicle among the plurality of vehicles 1-1 to 1-n a pass request signal for another vehicle, the control part 23 notifies the other vehicle that a pass request has arrived from the one vehicle. It is configured so that when the other vehicle has changed lanes or when the other vehicle has finished being passed by the one vehicle, it decreases the economic value held by the one vehicle or the user of the one vehicle and increases the economic value held by the other vehicle or the user of the other vehicle.

Due to this, an effect similar to the first embodiment is obtained. In addition, since the economic value is managed by the server 2, there is no longer a need for strangers with no acquaintance with each other to directly transfer economic value. For this reason, it is possible to secure reliability in transfer of economic value. Further, a notification of a pass request is sent from the server 2, so it is possible to eliminate the uncomfortable feeling due to a pass request directly arriving from a stranger with whom one is not acquainted.

Note that, the control part 23 may judge if the other vehicle has changed lanes or if the other vehicle has finished being passed by the one vehicle, for example, based on the current position information of the one vehicle and the other vehicle received through the communication part 21. Further, the control part 23 may additionally judge this when, for example, receiving a signal for payment of economic value sent from the one vehicle through the communication part 21.

Above, embodiments of the present disclosure were explained, but the above embodiments only show some of the examples of application of the present disclosure and are not meant to limit the technical scope of the present disclosure to the specific configurations of the embodiments.

1. An economic value processing system comprised of a plurality of vehicles able to communicate with each other and managing economic values held by the plurality of vehicles or users of the plurality of vehicles, wherein
when, based on a pass request signal sent from one vehicle among the plurality of vehicles to other vehicle, the other vehicle has changed lanes or the other vehicle has finished being passed by the one vehicle, the economic value processing system is configured to decrease the economic value held by the one vehicle or the user of one vehicle and increase the economic value held by the other vehicle or the user of the other vehicle.

2. The economic value processing system according to claim 1, wherein
the amount of decrease when decreasing the economic value held by the one vehicle or the user of the one vehicle is larger than the amount of increase when increasing the economic value held by the other vehicle or the user of the other vehicle.

3. The economic value processing system according to claim 1, wherein
the economic value processing system further comprises a server able to mutually communicate with the plurality of vehicles, and
the server is configured so as to grant economic value corresponding to a charge to a vehicle sending a purchase request signal or the user of that vehicle when receiving purchase request signals of economic value including charges from the plurality of vehicles.

4. The economic value processing system according to claim 3, wherein
the plurality of vehicles automatically send the purchase request signals to the server when the economic values held by the plurality of vehicles or the users of the plurality of vehicles fall to predetermined amounts or less.

5. The economic value processing system according to claim 1, wherein
the economic value processing system further comprises a server able to mutually communicate with the plurality of vehicles, and
the pass request is indirectly sent through the server from the one vehicle to the other vehicle and the economic values respectively held by the plurality of vehicles or the users of the plurality of vehicles are stored in the server.

6. A server comprising:
a communication part able to communicate with a plurality of mutually different vehicles;
a storage part storing economic values respectively held by the plurality of vehicles or the users of the plurality of vehicles; and
a control part managing the economic values, wherein
the control part is configured:
so that when receiving from one vehicle among the plurality of vehicles a pass request signal for other vehicle, it notifies the other vehicle that a pass request has arrived from the one vehicle; and
so that when the other vehicle changes lanes or the other vehicle finishes being passed by the one vehicle, it decreases the economic value held by the one vehicle or the user of the one vehicle and increases the economic value held by the other vehicle or the user of the other vehicle.

7. The server according to claim 6, wherein
the control part is configured to judge that the other vehicle has changed lanes or that the other vehicle has finished being passed based on current position information of the one vehicle and the other vehicle received through the communication part.

8. The server according to claim 6, wherein
the control part is configured to judge that the other vehicle has changed lanes or that the other vehicle has finished being passed by the one vehicle when receiving a signal for payment of the economic value sent from the one vehicle.
